(19) United States
(12) Patent Application Publication
(10) Pub. No.: US 2015/0127683 A1
(43) Pub. Date: May 7, 2015

(54) VEHICLE-END DATABASE MANAGEMENT SYSTEM

(71) Applicant: CHIH-CHENG LIN, TAINAN CITY (TW)

(72) Inventor: CHIH-CHENG LIN, TAINAN CITY (TW)

(21) Appl. No.: 14/465,216

(22) Filed: Aug. 21, 2014

(30) Foreign Application Priority Data
Nov. 1, 2013 (TW) 102139876

(51) Int. Cl. G06F 17/30; G06Q 50/26

(52) U.S. Cl. CPC G06F 17/30203; G06F 17/30109; G06Q 50/26
USPC 707/784

(57) ABSTRACT

A vehicle-end database management system is revealed. The vehicle-end database management system includes a read/write controller and a vehicle-end database manager. Data related to vehicles is written into the vehicle-end database manager by the read/write controller. Or data related to vehicles is read from the vehicle-end database manager by the read/write controller. Thus end-users can get the data related to vehicles timely so as to manage vehicles conveniently.

### BACKGROUND OF THE INVENTION

1. Fields of the Invention

The present invention relates to a vehicle-end database management system, especially to a vehicle-end database management system by which end-users can get the data related to vehicles timely so as to manage vehicles conveniently.

2. Descriptions of Related Art

The conventional way for identification and management of motor vehicles is mainly by using License Plate Recognition System and manual input of license plate information for performing manual search. For the License Plate Recognition System available now, the vehicles without the license plates thereon are unable to be identified. If some people remove the license plates on purpose for unlawful acts, police and prosecutors are difficult to get information related to these vehicles. Even the vehicles are affixed with the license plate, inspectors still need to contact staff with the system by phones or wireless communication for searching the license plate number and wait for the reply. This is inconvenient and time-consuming.

Moreover, data related to vehicles such as registration data, insurance data, etc., is printed on papers and issued to the vehicle owner. Take vehicle inspection as an example, staff of vehicle inspection stations first check vehicle registration and insurance card manually. Then check vehicle identification number (VIN) and engine number to complete the inspection. Next inspection date is recorded manually in a piece of paper which is rubber stamped by the inspection station. However, this is not only time-and-labor consuming, but also having poor economic benefits. Sometimes even vehicle registration and insurance card need to be renewed. Its a waste of resources. When police set up checkpoints for license and registration check, suspicious vehicles will be checked and the license plate number of suspicious vehicles is input into computers manually for vehicle identification. This way is inconvenient and time-consuming.

Furthermore, the license plate number, kilometers of travel, the parts replaced are all recorded in the computer database or directly written on adhesive tape attached to the front windshield by technicians for data management after maintenance and repair procedures being carried out. However, some bad used car dealers can easily change the vehicle mileage or modify the maintenance and repair record for raising the price of the vehicles. The rights and interests of consumers are impaired.

Thus there is room for improvement and a need to provide a novel vehicle data management system.

### SUMMARY OF THE INVENTION

Therefore it is a primary object of the present invention to provide a vehicle-end database management system in which data related to vehicles is divided into various levels by a vehicle-end database manager disposed on the vehicle so that end users can write/read data related to the vehicle into/from the system timely by a portable read/write controller. Thus the vehicles are managed conveniently.

In order to achieve the above object, a vehicle-end database management system of the present invention includes a read/write controller and a vehicle-end database manager.

The read/write controller consists of a central processing unit, an encoding/decoding unit, a non-contact transmission unit, an edit display unit and a write/read unit. The central processing unit is electrically connected to the encoding/decoding unit and the edit display unit while the write/read unit is electrically connected to the non-contact transmission unit and the encoding/decoding unit. A level value representing an end-user owning the read/write controller is built in the central processing unit. The central processing unit assigns the non-contact transmission unit an exclusive transmission authority according to the level value of the end-user for data transmission. The edit display unit is used to write the vehicle data in. The vehicle data written is displayed is on the edit display unit in a real time manner after being processed by the central processing unit. At the same time, the vehicle data written is sent to the encoding/decoding unit by the central processing unit for being encoded. Then the encoded vehicle data is passed through the write/read unit and is transmitted out by the non-contact transmission unit. The read/write controller receives the vehicle data read by the non-contact transmission unit. Then the vehicle data is passed through the write/read unit and decoded by the encoding /decoding unit. The decoded vehicle data is passed through the central processing unit and is sent to the edit display unit to be displayed.

The vehicle-end database manager is arranged at the vehicle and having a vehicle-end central processing unit (CPU), a vehicle-end database, a vehicle-end non-contact transmission unit and a written/read unit. The vehicle-end CPU is electrically connected to the vehicle-end database and the written/read unit while the written/read unit is electrically connected to the vehicle-end non-contact transmission unit. When the vehicle-end non-contact transmission unit receives the vehicle data, the vehicle data is sent through the written/read unit to the vehicle-end CPU for checking the exclusive transmission authority (level value) of each end-user and transmitting data. The vehicle-end database is divided into a plurality of level data access area according to the level value of the end-user. The vehicle-end CPU checks the end-user according to the transmission authority and further gets the level of the vehicle data. Then which level data access area of the vehicle-end database is/are accessible is determined according to the level value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a bock diagram showing structure of an embodiment of a vehicle-end database management system according to the present invention;

FIG. 2 is a schematic drawing showing an embodiment of a vehicle-end database management system in use according to the present invention;

FIG. 3 is a schematic drawing showing data range an end-user A can read and write in an embodiment of a vehicle-end database management system according to the present invention;

FIG. 4 is a schematic drawing showing data range an end-user B can read and write in an embodiment of a vehicle-end database management system according to the present invention;

FIG. 5 is a schematic drawing showing data range an end-user C can read and write in an embodiment of a vehicle-end database management system according to the present invention;

FIG. 6 is a schematic drawing showing data range an end-user D can read and write in an embodiment of a vehicle-end database management system according to the present invention;

FIG. 7 is a schematic drawing showing data range an end-user E can read and write in an embodiment of a vehicle-end database management system according to the present invention;

FIG. 8 is a schematic drawing showing data range an end-user F can read and write in an embodiment of a vehicle-end database management system according to the present invention;

FIG. 9 is a schematic drawing showing data range an end-user G can read and write in an embodiment of a vehicle-end database management system according to the present invention;

FIG. 10 is a schematic drawing showing data range an end-user H can read and write in an embodiment of a vehicle-end database management system according to the present invention;

FIG. 11A is a schematic drawing showing arrangement of an embodiment of a vehicle-end database management system by an end-user A according to the present invention;

FIG. 11B is an image displayed on an embodiment of a vehicle-end database management system when data is written into the vehicle-end database management system by an end-user A according to the present invention;

FIG. 12A is an image displayed on an embodiment of a vehicle-end database management system when data is read from the vehicle-end database management system by an end-user B according to the present invention;

FIG. 12B is an image displayed on an embodiment of a vehicle-end database management system when data is written into the vehicle-end database management system by an end-user B according to the present invention;

FIG. 12C is a schematic drawing showing an advantage of an embodiment of a vehicle-end database management system for an end-user B;

FIG. 13A is an image displayed on an embodiment of a vehicle-end database management system when data is read from the vehicle-end database management system by an end-user C according to the present invention;

FIG. 13B is a schematic drawing showing an advantage of an embodiment of a vehicle-end database management system for an end-user C;

FIG. 14A is a schematic drawing showing data is read from an embodiment of a vehicle-end database management system by an end-user D when police set up roadblocks and checkpoints for randomly pulling over drivers;

FIG. 14B is an image displayed on an embodiment of a vehicle-end database management system showing the vehicle-end database management system can connect to various kinds of database;

FIG. 14C is a schematic drawing showing data is read from an embodiment of a vehicle-end database management system by an end-user D when a traffic accident occurs;

FIG. 14D is a schematic drawing showing an advantage of an embodiment of a vehicle-end database management system for an end-user D;

FIG. 15A is an image displayed on an embodiment of a vehicle-end database management system showing an embodiment of a vehicle-end database management system used by an end-user E according to the present invention;

FIG. 15B is an image displayed on an embodiment of a vehicle-end database management system when data is written into the vehicle-end database management system by an end-user E according to the present invention;

FIG. 15C is an image displayed on an embodiment of a vehicle-end database management system when data is read from the vehicle-end database management system by an end-user E according to the present invention;

FIG. 15D is a schematic drawing showing an advantage of an embodiment of a vehicle-end database management system for an end-user E;

FIG. 16A is an image displayed on an embodiment of a vehicle-end database management system when data is read from the vehicle-end database management system by an end-user F according to the present invention;

FIG. 16B is an image displayed on an embodiment of a vehicle-end database management system when data is written into the vehicle-end database management system by an end-user F according to the present invention;

FIG. 17A is an image displayed on an embodiment of a vehicle-end database management system when data is read from the vehicle-end database management system by an end-user G according to the present invention;

FIG. 17B is an image displayed on an embodiment of a vehicle-end database management system when data is written into the vehicle-end database management system by an end-user G according to the present invention;

FIG. 17C is a schematic drawing showing an advantage of an embodiment of a vehicle-end database management system for an end-user G;

FIG. 18A is an image displayed on an embodiment of a vehicle-end database management system showing an embodiment of a vehicle-end database management system used by an end-user H according to the present invention;

FIG. 18B is an image displayed on an embodiment of a vehicle-end database management system when data is read from the vehicle-end database management system by an end-user H according to the present invention;

FIG. 18C is an image displayed on an embodiment of a vehicle-end database management system when data is read from the vehicle-end database management system by an end-user H according to the present invention;

FIG. 18D is an image displayed on an embodiment of a vehicle-end database management system when data is written into the vehicle-end database management system by an end-user H according to the present invention.

### DETAILED DESCRIPTION OF THE PREFERRED EMBODIMENT

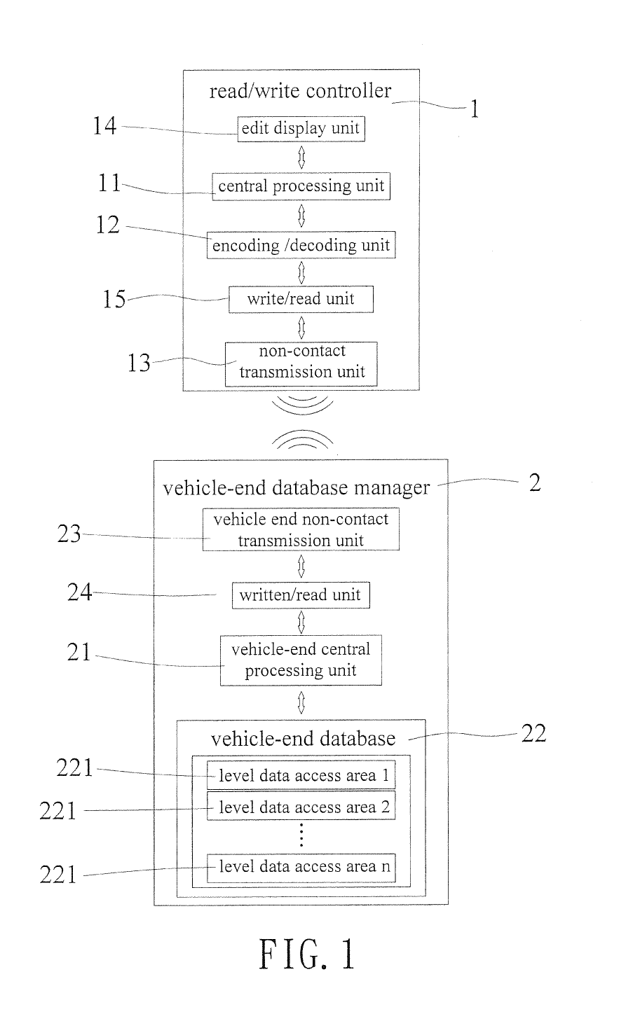

Refer to FIG. 1, a schematic drawing showing structure of a vehicle-end database management system of the present invention is revealed. The vehicle-end database management system includes a read/write controller 1 and a vehicle-end database manager 2.

The read/write controller 1 is a portable controller and having a central processing unit 11, an encoding/decoding unit 12, a non-contact transmission unit 13, an edit display unit 14 and a write/read unit 15. The central processing unit 11 is electrically connected to the encoding /decoding unit 12, the non-contact transmission unit 13, the edit display unit 14 and the write/read unit 15. A level value representing an end-user owning the read/write controller 1 is built in the central processing unit 11. The end-user can be vehicle manufacturers (end-user A), motor vehicles officers (end-user B), vehicle inspection stations (end-user C), police, prosecutors, and Investigation bureau inspectors (end-user D), insurance units (end-user E), exhaust emission test stations (end-user F), loan banks (end-user G), Auto maintenance companies (end-user H), etc. The CPU 11 assigns the non-contact transmission unit 13 of each end-user an exclusive transmission authority according to the level value of each end-user. The vehicle data is transmitted by the non-contact transmission unit 13 according to the exclusive transmission authority the central processing unit 11 assigned. The edit display unit 14 is used for inputting the vehicle data and display of data being written or read. As to the encoding/decoding unit 12, it encodes the data intended to be written into the vehicle-end database manager 2 and decodes the data the vehicle-end database manager 2 read. The data is written into the read/write controller 1 by the edit display unit 14 and is displayed on the edit display unit 14 through the central processing unit 11. At the same time, the data written is sent to the write/read unit 15 after being encoded by the encoding /decoding unit 12 and then is transmitted out by the non-contact transmission unit 13. The read/write controller 1 receives the vehicle data read by the non-contact transmission unit 13. The vehicle data read is passed through the write/read unit 15, decoded by the encoding/decoding unit 12, passed through the central processing unit 11 and then sent to the edit display unit 14 to be displayed.

The vehicle-end database manager 2 is disposed on a back side of a rearview mirror or a dashboard of a vehicle. The vehicle-end database manager 2 consists of a vehicle-end central processing unit (CPU) 21, a vehicle-end database 22, a vehicle-end non-contact transmission unit 23 and a written/read unit 24. The vehicle-end CPU 21 is electrically connected to the vehicle-end database 22 and the written/read unit 24 while the written/read unit 24 is electrically connected to the vehicle-end non-contact transmission unit 23. According to the level of the end-user (such as end-user A to H), the vehicle-end database manager 2 assigns the non-contact transmission unit 13 of each end-user a corresponding transmission authority. Each end-user has its own authority for data transmission. A plurality of level data access area 221 corresponding to the level of the end-user is built in the vehicle-end database 22. Which data access area of the vehicle-end database 22 is/are accessible is determined according to the level of the end-user. When the vehicle end non-contact transmission unit 23 receives the vehicle data written by the read/write controller 1, the vehicle data written is sent through the written/read unit 24 to the vehicle-end CPU 21 for checking the level of the end-user. According to the result of the level checking, the written vehicle data is saved in the corresponding level data access area 221 of the vehicle-end database 22. When the vehicle-end non-contact transmission unit 23 receives an output signal from the read/write controller 1 for reading vehicle data in the vehicle-end database manager 2, the output signal for reading is sent through the written/read unit 24 to the vehicle-end CPU 21 for checking the level of the end-user. In accordance with the result of the level checking, the vehicle data originally saved in the corresponding level data access area 221 of the vehicle-end database 22 is transmitted to the vehicle-end CPU 21, passed through the written/read unit 24 to be delivered out by the vehicle-end non-contact transmission unit 23.

While being shipped out of the factory, both hardware and firmware in the read/write controller 1 have already been settled down. Thus the vehicle-end non-contact transmission unit 23 of the vehicle-end database manager 2 is also set with a certain number of transmission authorities corresponding to the preset number of end-users with different levels. The number of the level can also be set in advance.

Thereby each end-user has its own read/write controller 1. The vehicle data can only be transmitted between the read/write controller 1 and the vehicle-end database manager 2 according to the exclusive transmission authority set therein.

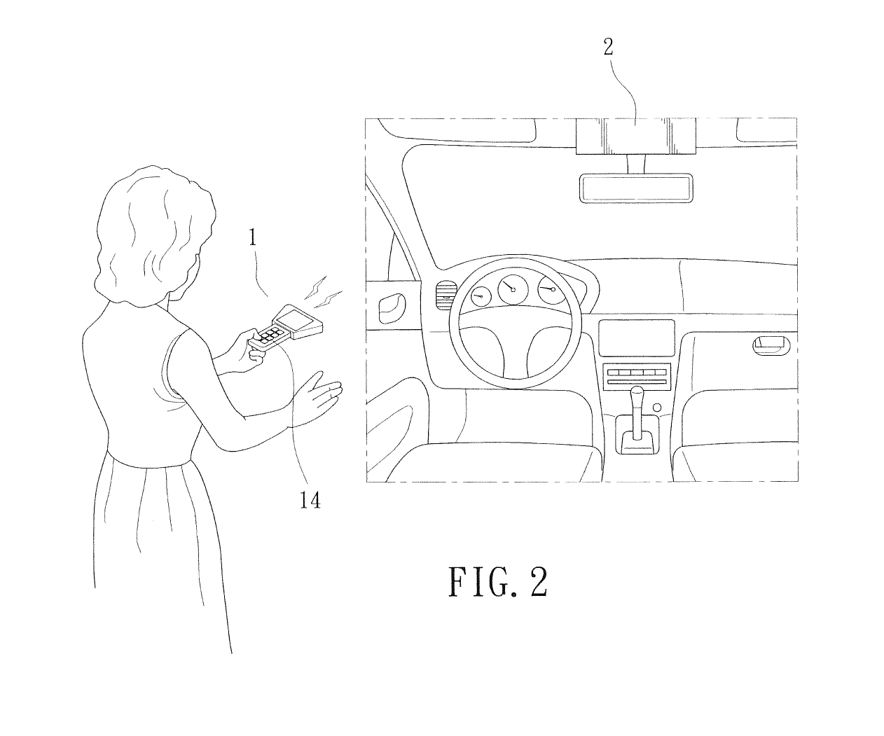

Refer to FIG. 2, when an end-user intends to write vehicle related data into the system of the present invention, the data is written into the system by the edit display unit 14 of the read/write controller 1 specific to the end-user. The vehicle related data written is also sent to the edit display unit 14 through the central processing unit 11 to be displayed. At the same time, the central processing unit 11 also sends the vehicle related data to the encoding/decoding unit 12 for being encoded. The encoded vehicle related data is sent through the write/read unit 15 to the non-contact transmission unit 13 with the exclusive transmission authority for being transmitted. As to the vehicle-end database manager 2 disposed on the vehicle, it receives the vehicle related data written by the vehicle-end non-contact transmission unit 23 having the transmission authority corresponding to the non-contact transmission unit 13 of the read/write controller 1. The vehicle related data received is sent through the written/read unit 24 to the vehicle-end central processing unit (CPU) 21 for checking the level and the corresponding authority. According to the result of the level and authority checking, the written vehicle data is saved in the corresponding level data access area 221 of the vehicle-end database 22 by the vehicle end CPU 21.

When an end-user intends to read vehicle related data from the system of the present invention, an output signal for reading vehicle data is transmitted by the non-contact transmission unit 13 of the read/write controller 1 specific to the end-user. After the output signal for reading vehicle data being received by the vehicle-end non-contact transmission unit 23 of the vehicle-end database manager 2 on the vehicle, the output signal is sent through the written/read unit 24 to the vehicle-end CPU 21 for checking the level and authority of the end-user. According to the checking result of the level and authority, the vehicle-end CPU 21 gets the vehicle data in the level data access area 221 of the vehicle-end database 22 corresponding to the level and authority checked. Then the vehicle data read is transmitted through the written/read unit 24 to be sent out by the vehicle-end non-contact transmission unit 23. Next the vehicle data is received by the non-contact transmission unit 13 of the read/write controller 1. The vehicle data received in sent through the write/read unit 15 to the encoding/decoding unit 12 for being decoded. The decoded vehicle data is the vehicle data originally input. At last, the central processing unit 11 controls the edit display unit 14 to show the vehicle data originally input. The reading of the vehicle data has been completed.

### Embodiment

In the vehicle-end database management system, vehicle data related to each end-user (from A to H) saved in the vehicle-end database 22 of the vehicle-end database manager 2 is as following:

Data related to the end-user A (vehicle manufacturers):

A

| | | | |
|---|---|---|---|
| A1 serial | A2 vehicle | A3 type of | A4 model |
| number | year made | vehicle | |
| A5 brand | A6 color | A7 engine | A8 engine |
| | | horsepower | number |
| A9 | A10 vehicle | A11 | A12 vehicle |
| displacement | identification | number of | length |
| | number (VIN) | cylinders | |
| A13 type | A14 total | A15 total | A16 loading |
| of body | weight | weight of | capacity |
| | | tractor | |
| A17 loading | A18 date of | A19 fuel | A20 issuing |
| capacity of | MFG(manufac- | type | manufacturer |
| 5^{th} wheel | ture) | | |

Data related to the end-user (motor vehicles offices):

B

| B1 document | B2 license | B3 type of | B4 vehicle |
|---|---|---|---|
| No. | plate No. | vehicle | owner |
| B5 address | B6 brand | B7 date of | B8 model |
| | | MFG(manufacture) | |
| B9 | B10 fuel type | B11 type of body | |
| displacement | | and added equipment | |
| B12 engine | B13 vehicle | B14 number of | B15 seat for |
| No. | identification | people carried | driver |
| | number (VIN) | | |
| B16 loading | B17 total | B18 total | B19 vehicle |
| capacity | weight | weight of | mobilization |
| | | tractor | No. |
| B20 service | | B21 | B22 original |
| company or renter | | reference | license |
| | | No. | issued date |
| B23 reissued | B24 expiry | B25 color | B26 length |
| Date | Date | | of carriage |
| B27 other | B28 | B29 | B30 |
| remarks | scheduled | inspection | inspection |
| | inspection | date | agency |
| | date | | |

Data related to the end-user C: (vehicle inspection stations and private vehicle inspection stations):

C

| | | | |
|---|---|---|---|
| C1 license | C2 vehicle | C3 address | C4 engine |
| plate No. | owner | | No. |
| C5 scheduled | C6 | C7 | |
| inspection | inspection | inspection | |
| date | date | agency | |

Data related to the end-user D (police, prosecutors, and investigation bureau inspectors):

D

| D1 document | D2 license | D3 type of | D4 vehicle |
|---|---|---|---|
| No. | plate No. | vehicle | owner |
| D5 address | D6 brand | D7 date of | D8 model |
| | | MFG | |
| D9 | D10 fuel type | D11 type of body | |
| displacement | | and added equipment | |
| D12 engine | D13 vehicle | D14 number | D15 seat for |
| No. | identification | of people | driver |
| | number (VIN) | carried | |
| D16 loading | D17 total | D18 total | D19 vehicle |
| capacity | weight | weight of | mobilization |
| | | tractor | No. |
| D20 service | | D21 | D22 original |
| company or renter | | reference | license issued |
| | | No | date |
| D23 reissued | D24 expiry | D25 color | D26 length of |
| date | Date | | carriage |
| D27 other | D28 stolen | D29 major | D30 liability |
| remarks | vehicle | traffic | insurance |
| | notification | accidents | |
| D31 periodic | D32 traffic | D33 vehicle | D34 |
| vehicle | ticket | with taxes | bank |
| inspection | | not paid | reporting |

Data related to the end-user E (insurance unit):

E

| | | | |
|---|---|---|---|
| E1 license | E2 vehicle | E3 address | E4 engine |
| plate No. | owner | | No. |
| E5 | E6 | E7 | E8 |
| certificate | insurance | insurance | insurance |
| No. | period | coverage | unit (company) |
| E9 insurance | E10 other | | |
| unit (phone) | remarks | | |

Data related to the end-user F (exhaust emission test stations):

F

| | | | |
|---|---|---|---|
| F1 license | F2 vehicle | F3 address | F4 engine |
| plate No. | owner | | No. |
| F5 test No. | F6 test | F7 phone No. | F8 test |
| | agency | | content |
| F9 test date | | | |

Data related to the end-user G (banks):

G

| | | | |
|---|---|---|---|
| G1 license | G2 vehicle | G3 address | G4 engine |
| plate No. | owner | | No. |
| G5 reference no. | G6 processing | G7 phone No. | G8 amount |
| | unit (bank) | | |
| G9 period | | | |

Data related to the end-user H (Auto maintenance companies):

H

| | | | |
|---|---|---|---|
| H1 license | H2 vehicle | H3 address | H4 engine |
| plate No. | owner | | No. |
| H5 | H6 phone No. | H7 vehicle | H8 |
| processing No. | | mileage | maintenance |
| | | | content |
| H9 | | | |
| maintenance | | | |
| date | | | |

The data range in the vehicle-end database management system each end-user (from A to H) can read and written is determined according to the level of the end-user. In the figures, → represents that the end-user can write the data while → represents that the end-user can read the data.

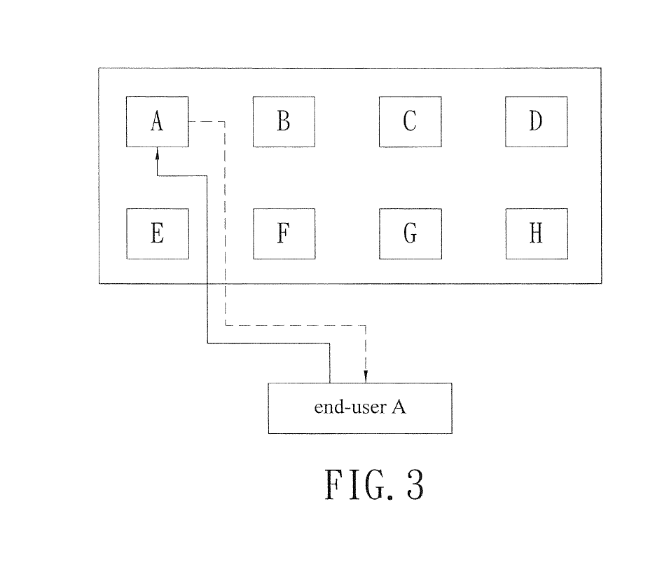

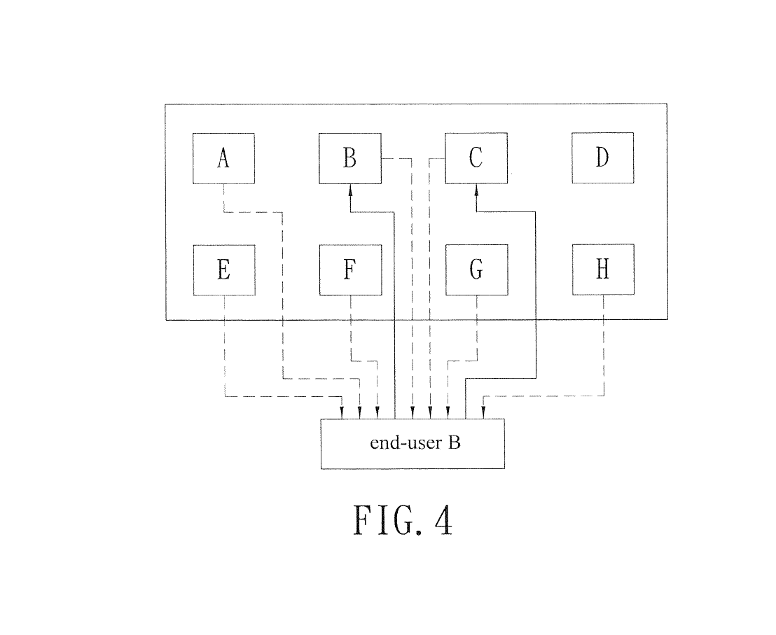

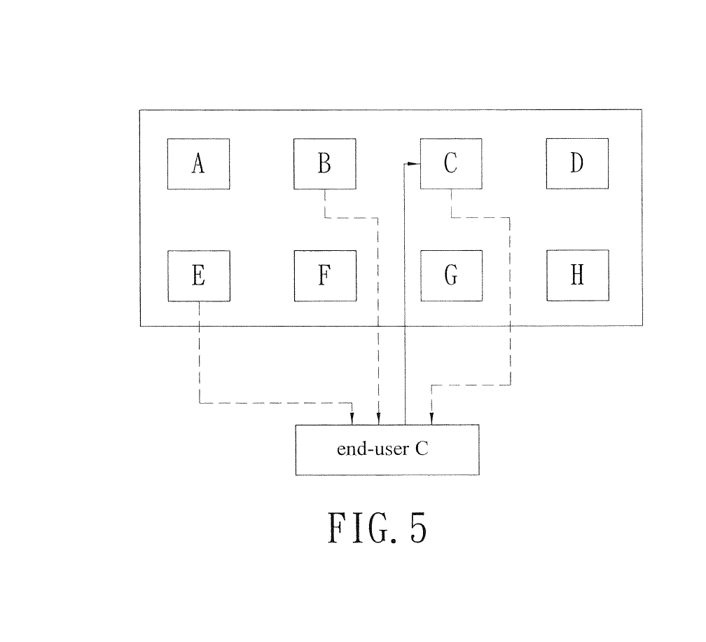

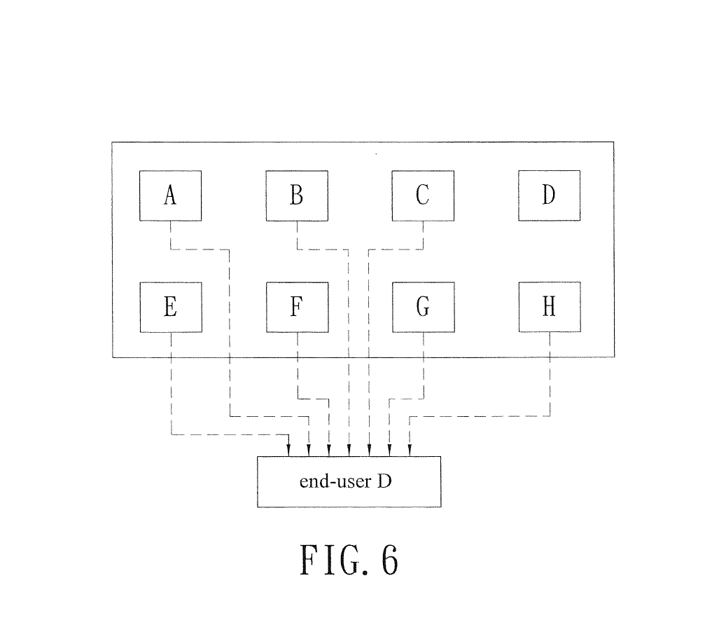

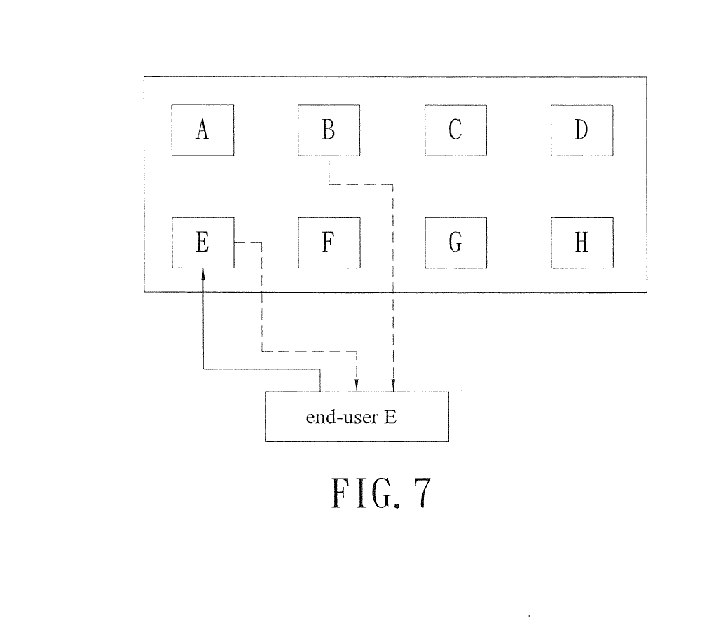

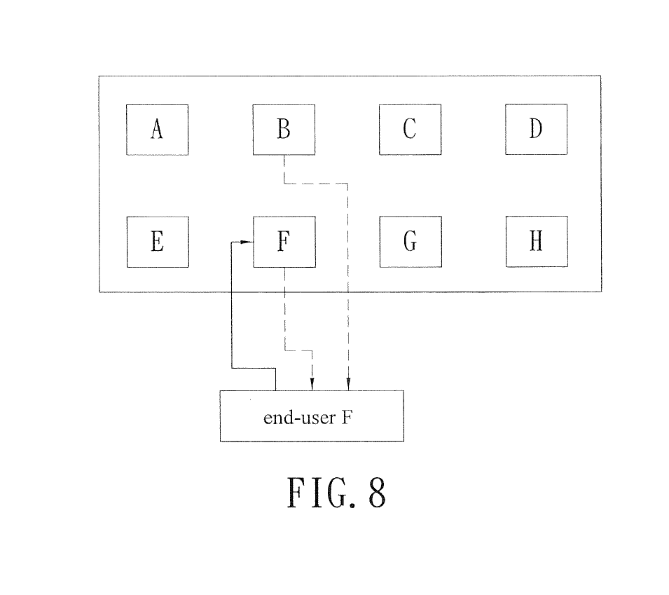

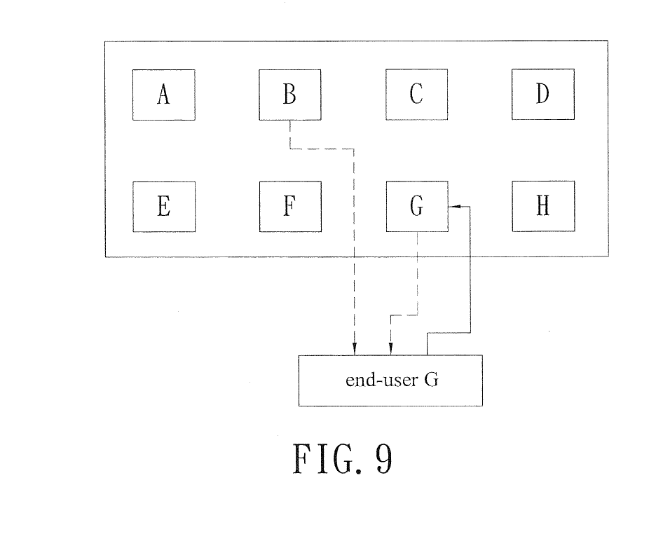

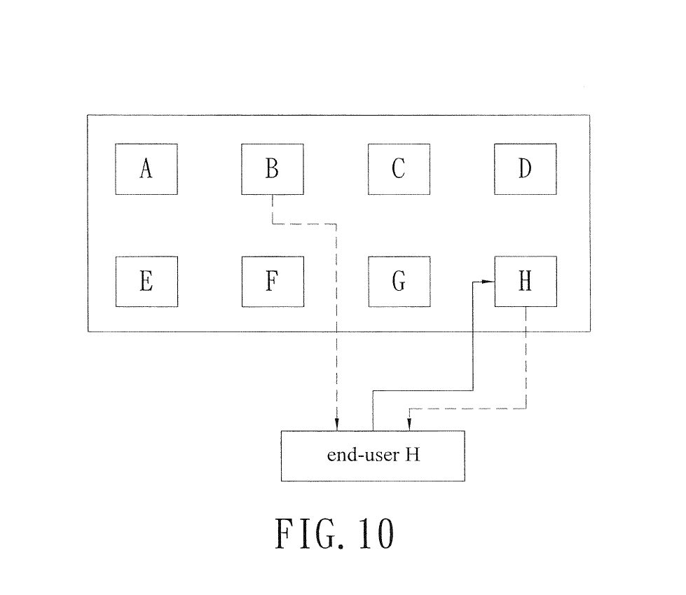

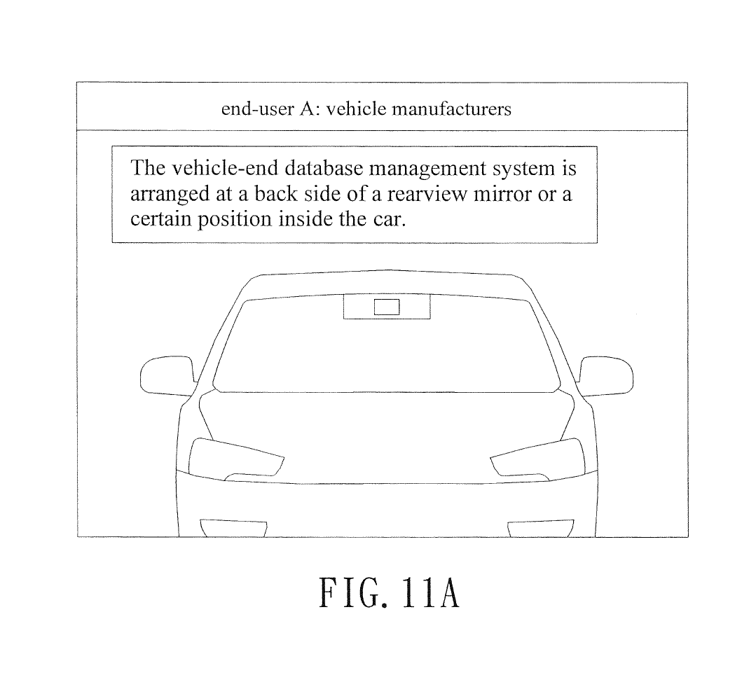

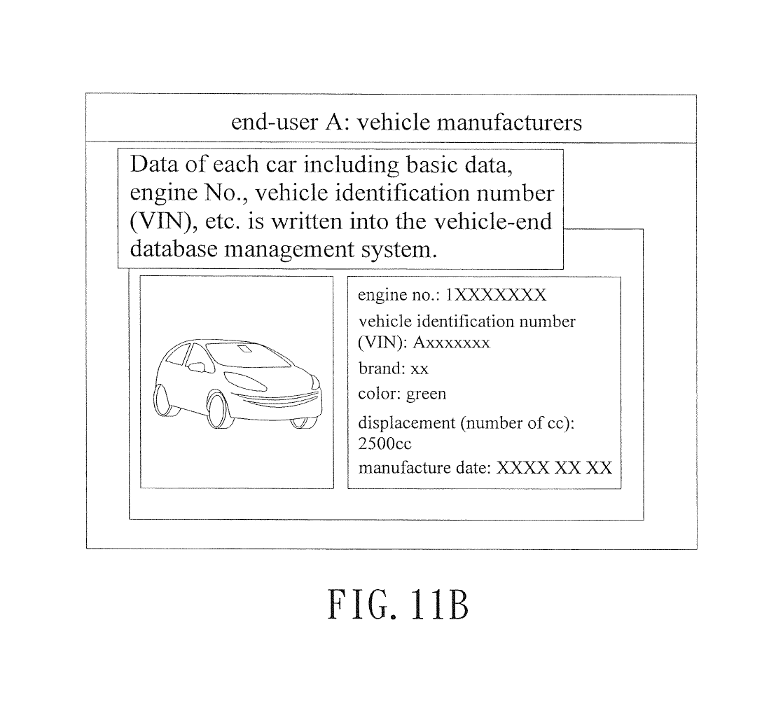

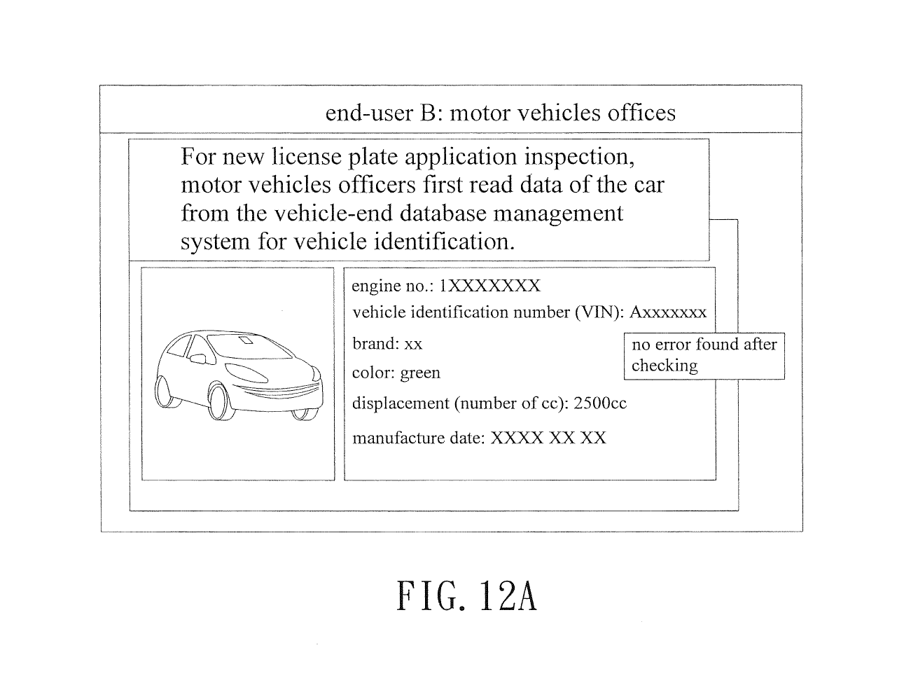

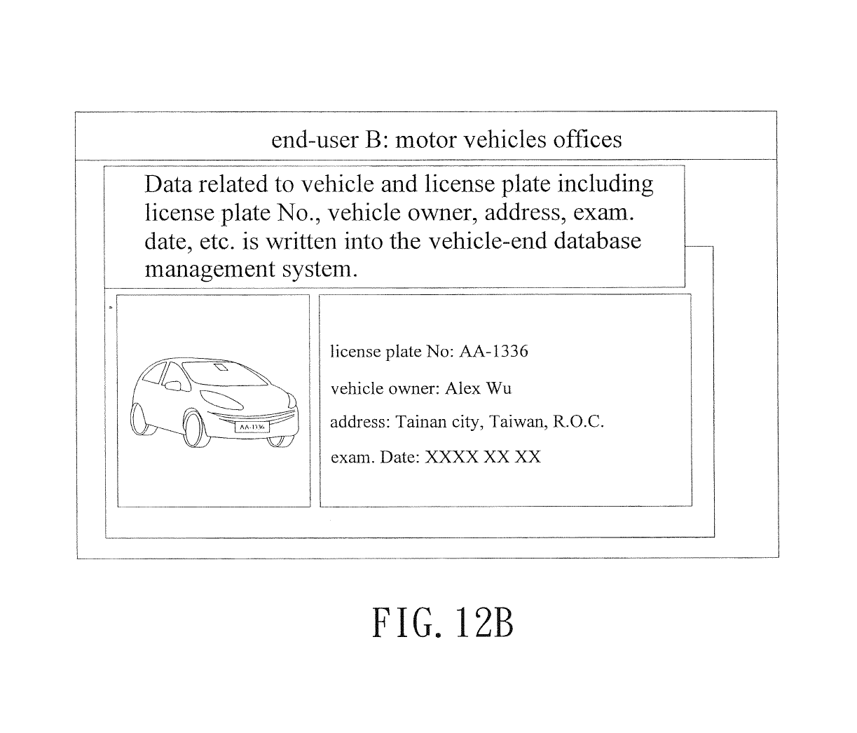

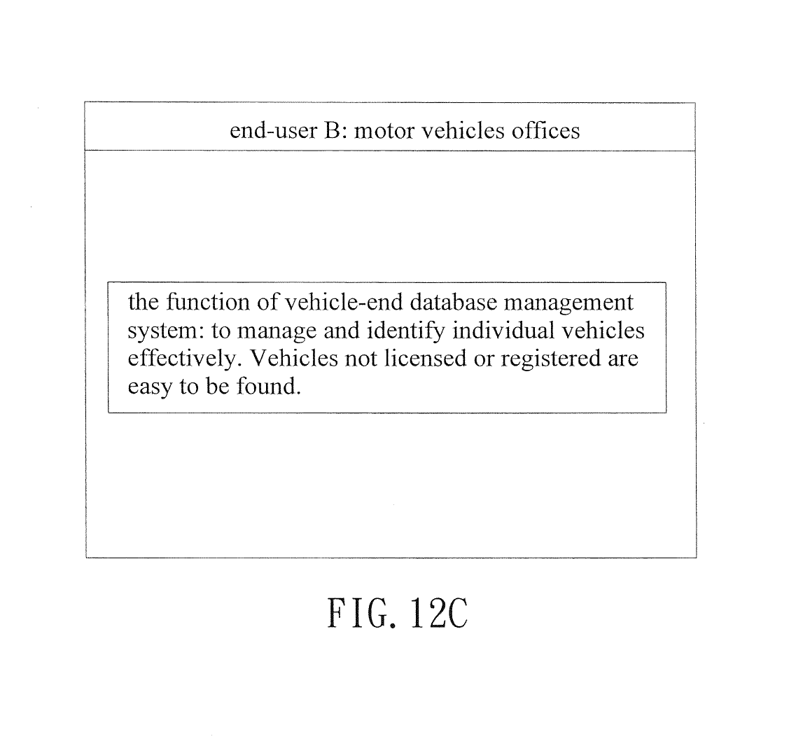

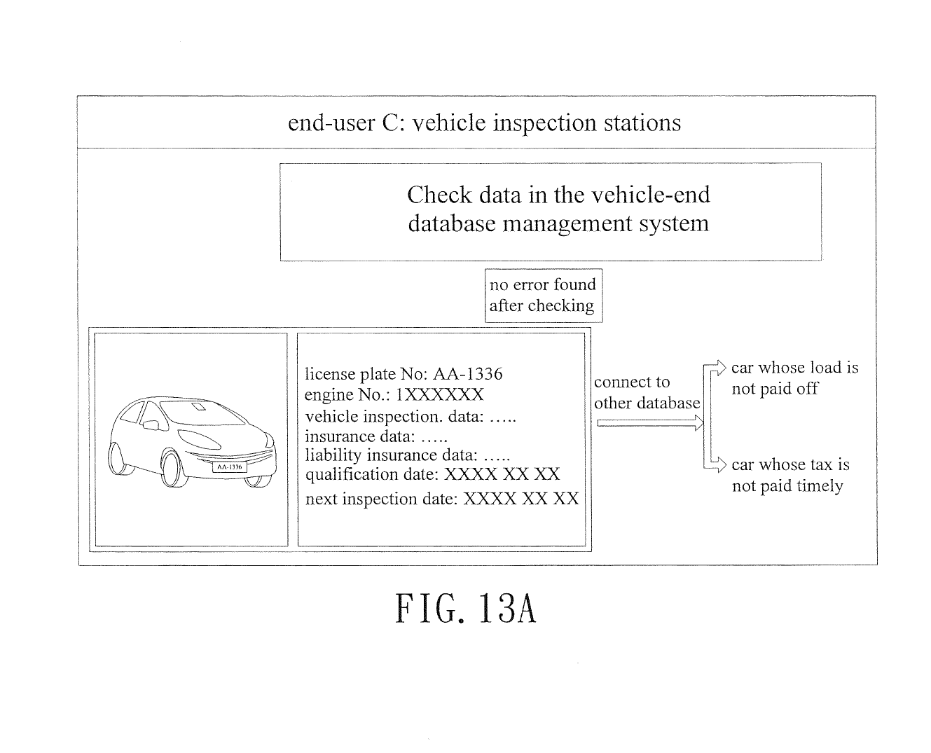

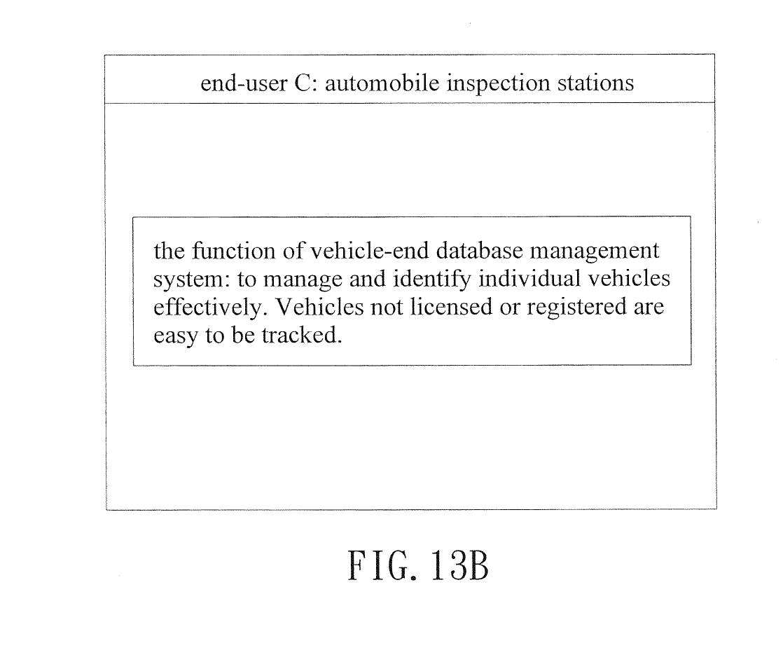

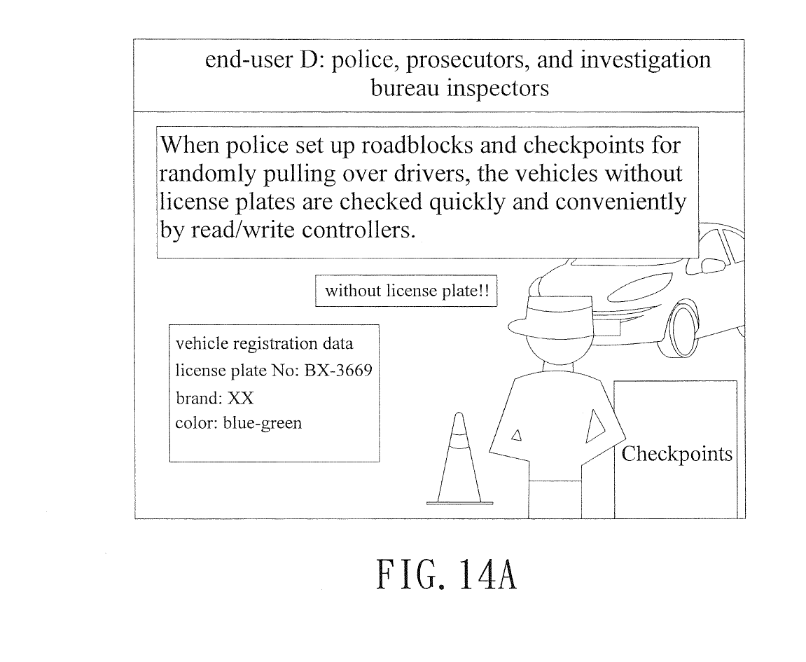

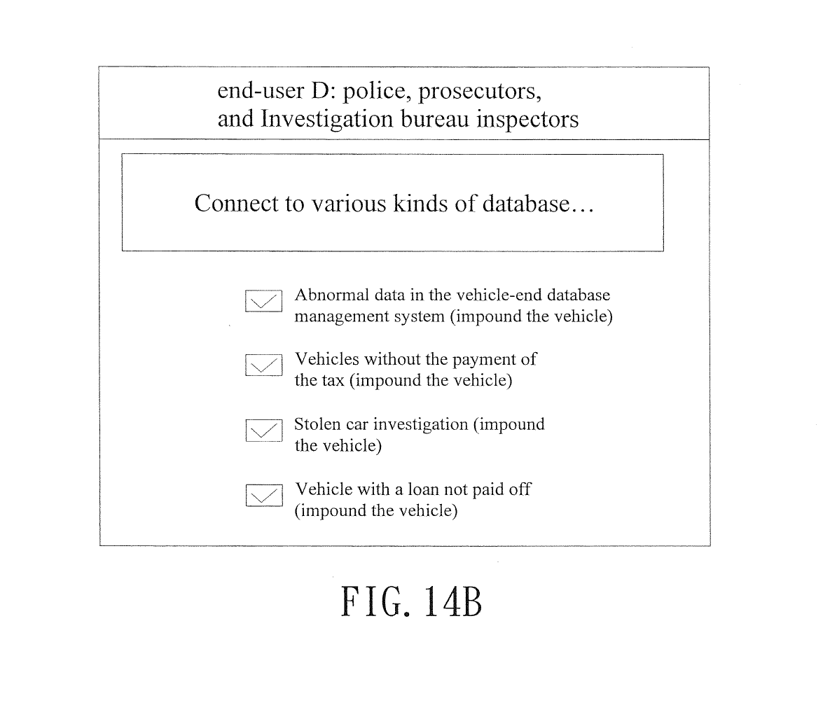

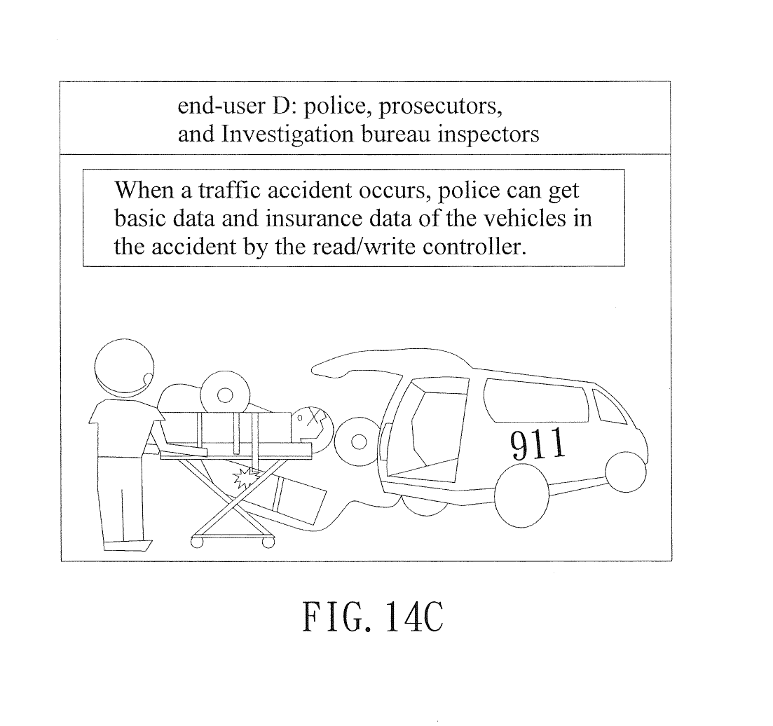

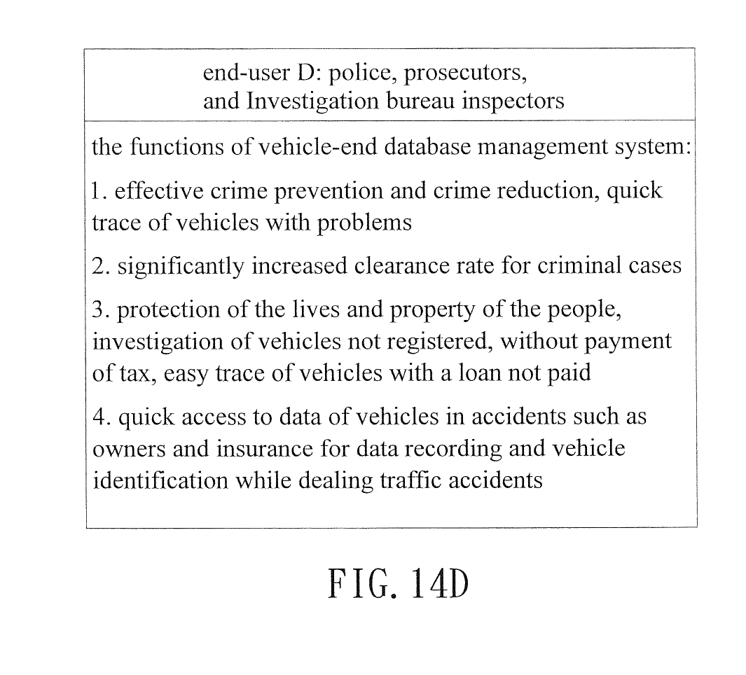

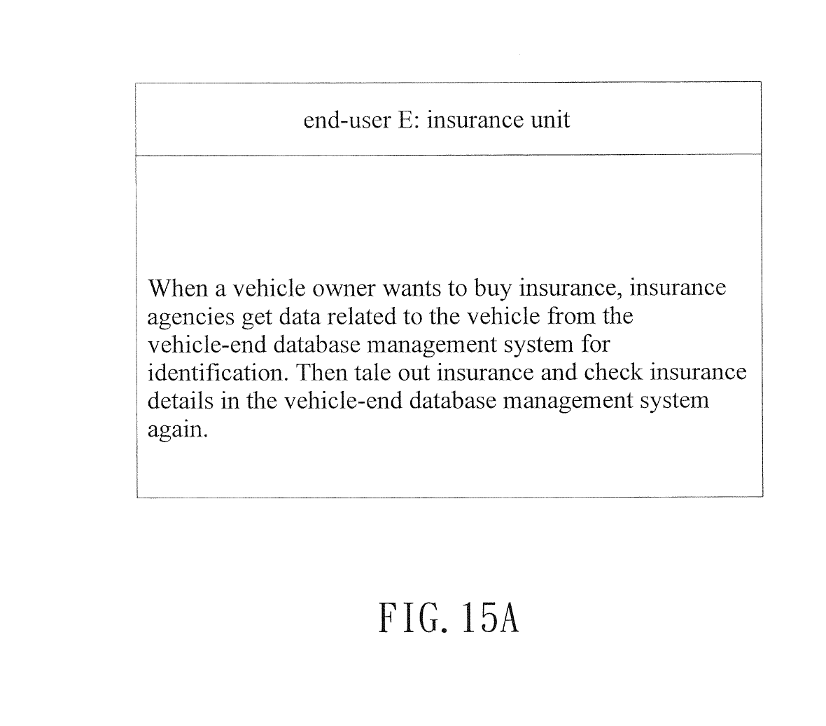

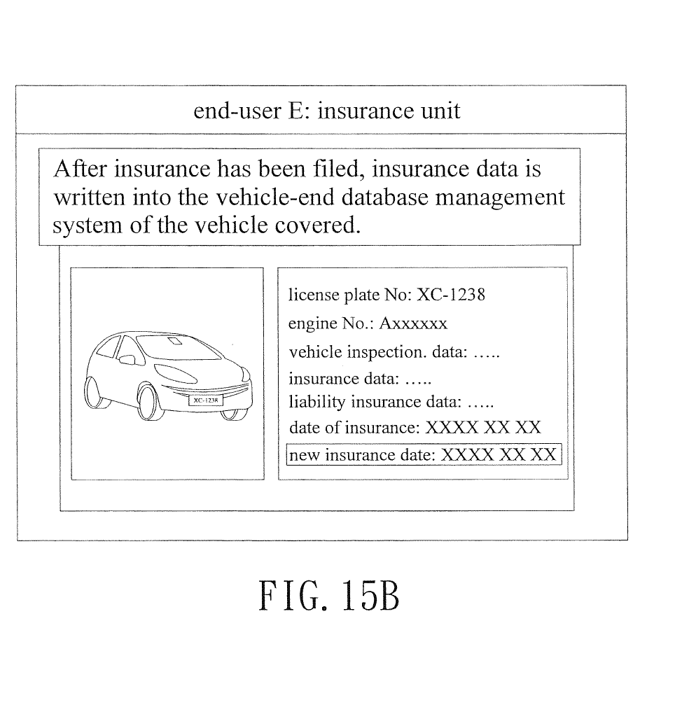

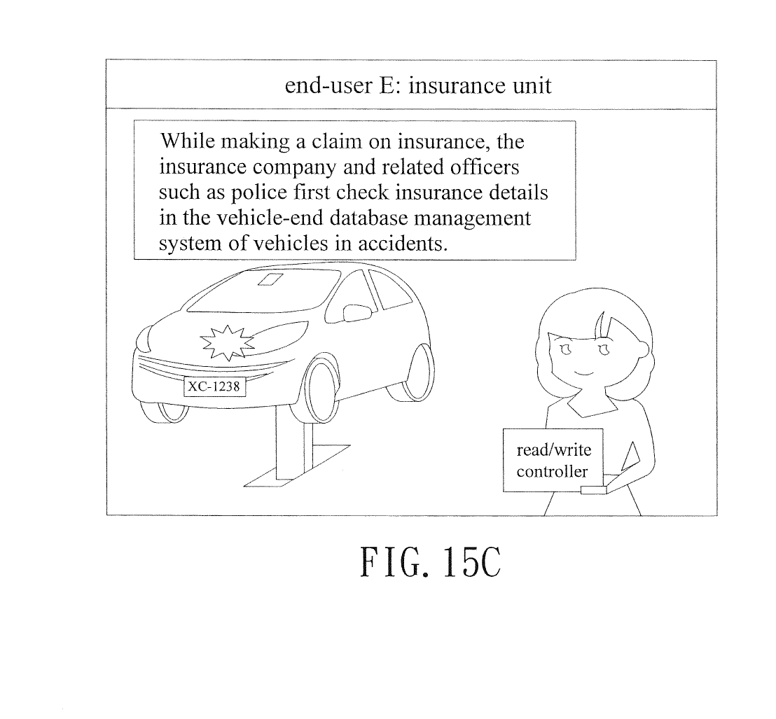

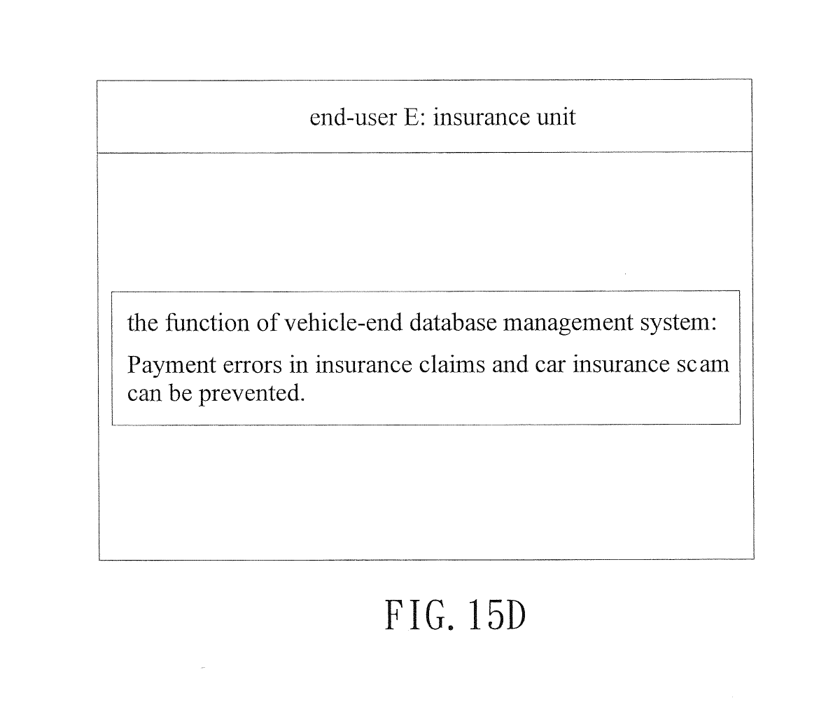

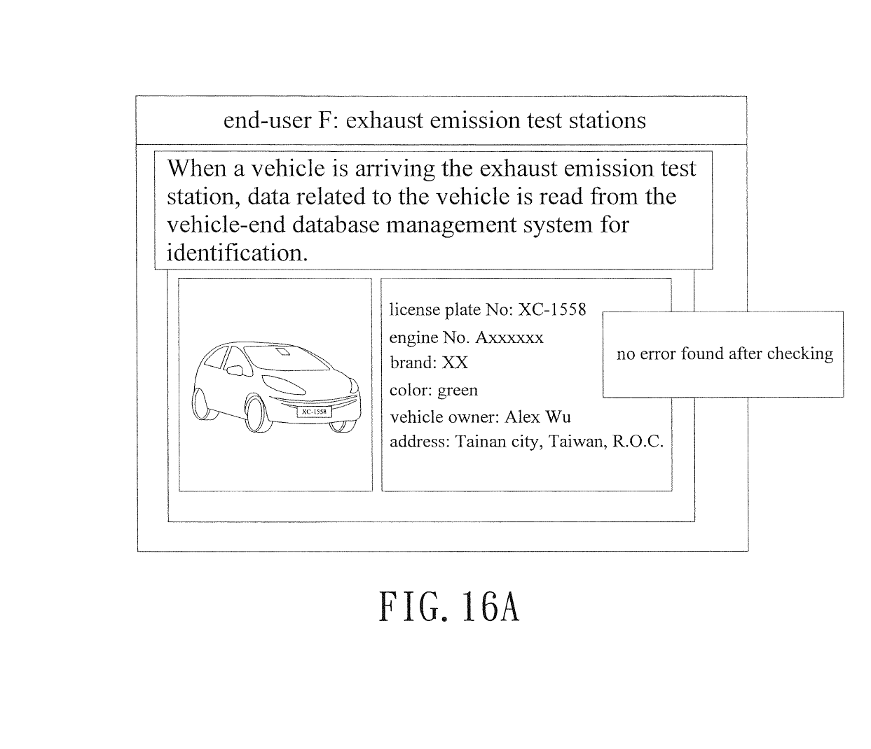

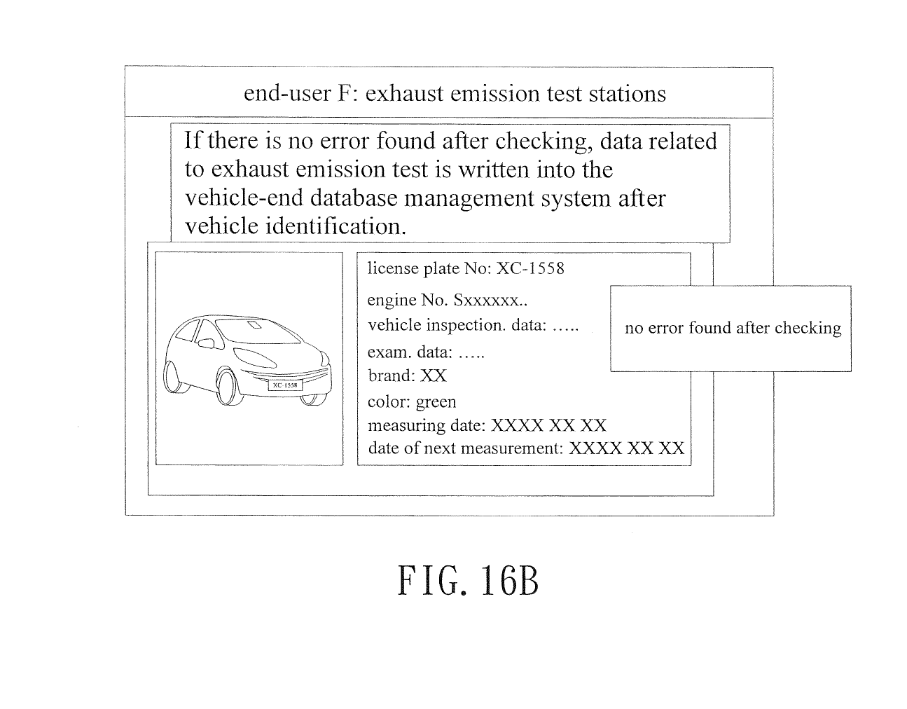

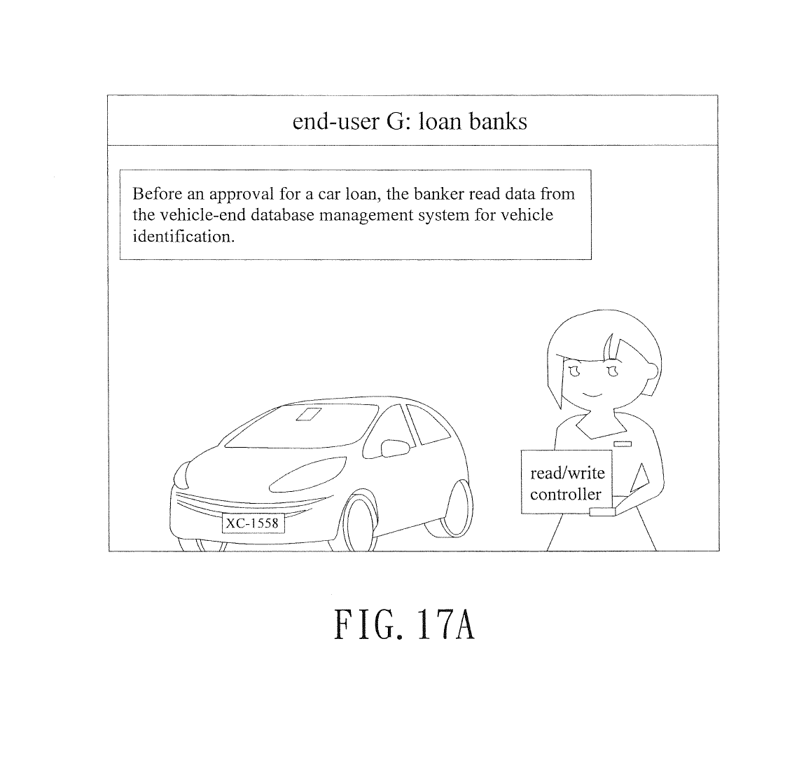

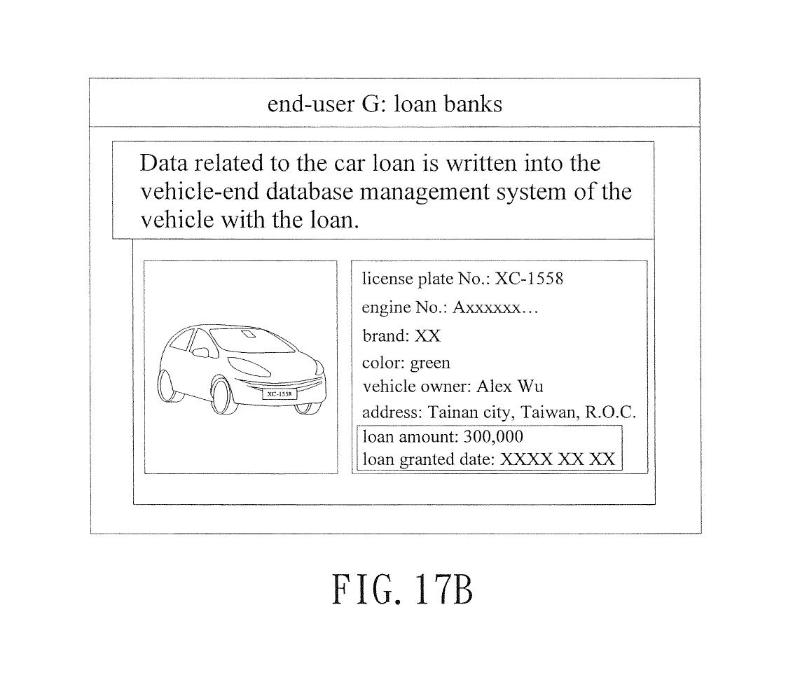

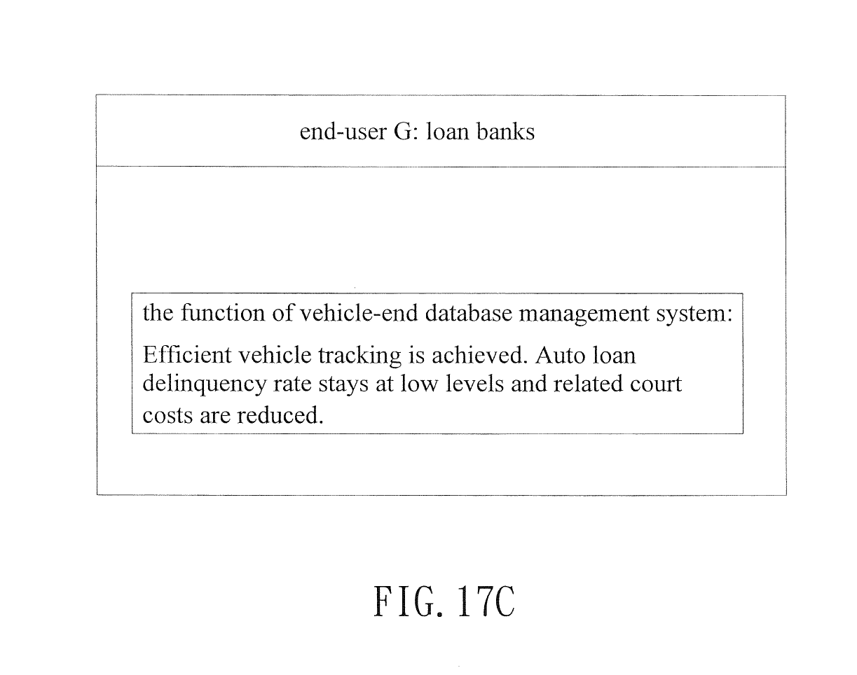

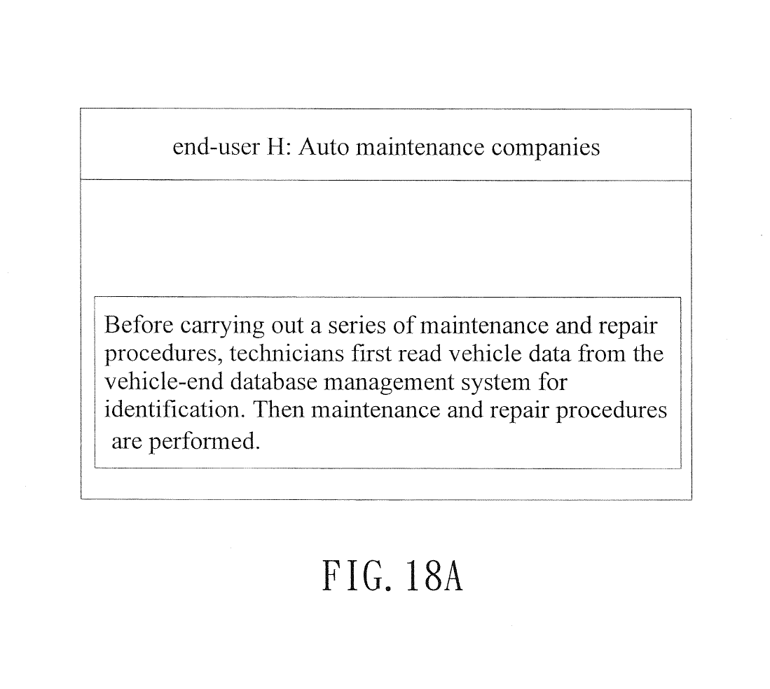

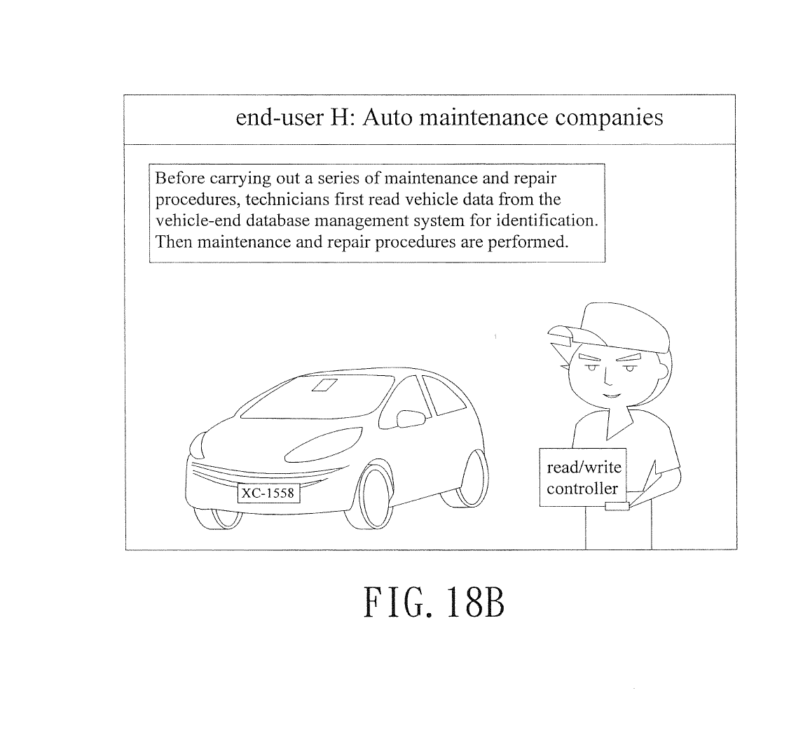

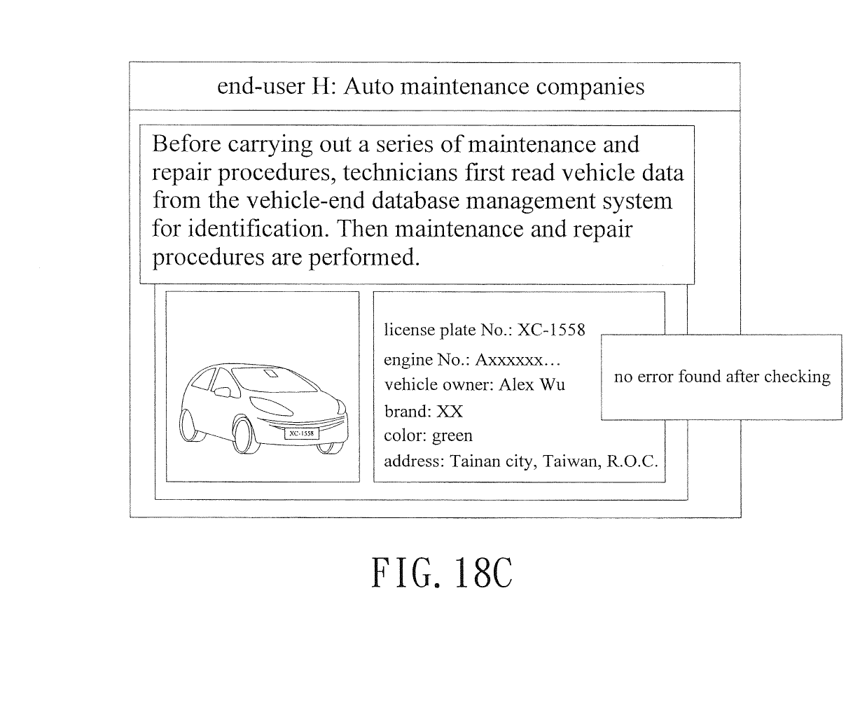

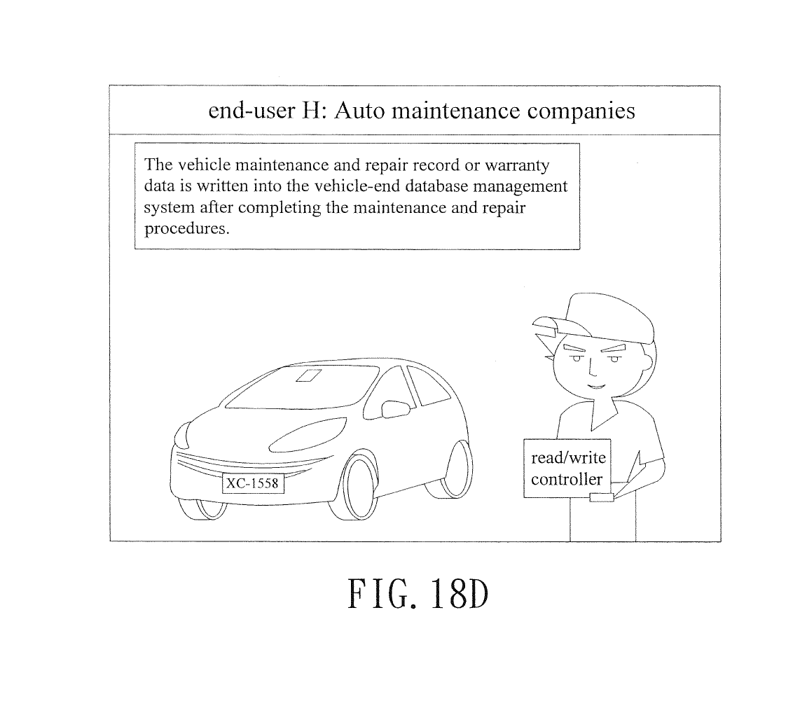

Refer to FIG. 3, the end-user A can only read and write data A. Also refer to FIG. 11A and FIG. 11B, the position of the system is shown and data related to each vehicle can be written into the system. Refer to FIG. 4, the end-user B can read data A, data B, data C, data E, data F, data G, and data H while data B and data C can be written by the end-user B. Also refer to FIG. 12A, FIG. 12B and FIG. 12C, the motor vehicles officers first read data of the car from the system for vehicle identification and then write data related to vehicle and license plate into the system. Thus individual vehicles are identified and managed effectively and vehicles not licensed or registered are easy to be found. Refer to FIG. 5, the end-user C can read a part of data B (a part of data is kept confidential), data C and data E while only data C can be written by the end-user C. Also refer to FIG. 13A, FIG. 13B, vehicle data in the system is checked by the end-user C. Once there is no error found after checking, the system is connected to other database for checking whether the loan is not paid off or the tax is not paid timely. Thus individual vehicles are managed and identified effectively. Vehicles not licensed or registered are easy to be tracked. Refer to FIG. 6, the end-user D can read data A, data B, data C, data D, data E, data F, data G, and data H while the end-user D can't write any piece of data. Also refer to FIG. 14A, FIG. 14B, FIG. 14C, and FIG. 14D, when police set up roadblocks and checkpoints for randomly pulling over drivers, the vehicles without license plates are checked quickly and conveniently by read/write controllers. Or when a traffic accident occurs, police can get basic data and insurance data of the vehicles in the accident by the read/write controller. The system can connect to various kinds of database so as to find abnormal data in the system, vehicles without the payment of the tax, stolen cars, or vehicles with a loan not paid off. And the vehicles are impounded. The system can be applied to effective crime prevention, increased clearance rate of criminal cases, protection of the lives and property of people, and quick access to data of vehicles in The system can be applied to effective crime prevention, increased clearance rate of criminal cases, protection of the lives and property of people, and quick access to data of vehicles in accidents. Refer to FIG. 7, the end-user E can read a part of data B (a part of data is kept confidential) and data E while only data E can be written by the end-user E. Also refer to FIG. 15A, FIG. 15B, FIG. 15C and FIG. 15D, insurance agencies get data related to the vehicle from the system for identification when a vehicle owner wants to buy insurance. Then take out insurance and check insurance details in the system again. After insurance has been filed, insurance data is written into the system of the vehicle covered. While making a claim on insurance, the insurance company and related officers such as police first check insurance details in the system of vehicles in accidents. Thus payment errors in insurance claims and car insurance scam can be prevented. Refer to FIG. 8, the end-user F can read a part of data B (a part of data is kept confidential) and data F while only data F can be written by the end-user F. Also refer to FIG. 16A and FIG. 16B, data related to the vehicle is read from the system for identification when a vehicle is at the exhaust emission test station. If there is no error found after checking, data related to exhaust gas measurement is written into the system after vehicle identification. Refer to FIG. 9, the end-user G can read a part of data B (a part of data is kept confidential) and data G while only data G can be written by the end-user G. Also refer to FIG. 17A, FIG. 17B, and FIG. 17C, the banker read data from the system for vehicle identification before an approval for a car loan. Data related to the car loan is written into the system of the vehicle with the loan. Thus efficient vehicle tracking is achieved. Auto loan delinquency rate stays at low levels and related court costs are reduced. Refer to FIG. 10, the end-user H can read a part of data B (a part of data is kept confidential) and data H while only data H can be written by the end-user H. Also refer to FIG. 18A, FIG. 18B, FIG. 18C and FIG. 18D), B, technicians first read vehicle data from the system for identification before carrying out a series of maintenance and repair procedures. Then maintenance and repair procedures are performed. The vehicle maintenance and repair record or warranty data is written into the system after completing the maintenance and repair procedures.

According to the above embodiments, the data stored in the vehicle-end database manager 2 of the present invention and the corresponding levels are clearly illustrated. As to the level values set in the read/write controller 1, it affects the authority of each end-user to read data in the vehicle-end database manager 2 or write data into the vehicle-end database manager 2.

Moreover, the difference between conventional recognition and management system for vehicles and the system of the present invention is in that: the conventional system is based on the recognition of vehicle license plate, manual input and manual search. Yet the present invention features on a plurality of benefits including fast recognition, convenience, preventative observation, precision, reliability, functionality, effectiveness, energy saving property, usefulness, etc. In the system of the present invention, various kinds of end-users and data read or written by each end-user are built in the system in advance. Thus even vehicles without license plates can be identified quickly. There is no need to connect the system to various kinds of database. Furthermore, the system of the present invention can be used in combination with monitoring systems at major intersections and license plate recognition systems. Thus original and correct data of the vehicles can be obtained and checked for vehicle identification.

In addition, the transmission way of the non-contact transmission unit 13 and of the vehicle-end non-contact transmission unit 23 mentioned above can be microwave transmission, electromagnetic transmission, magnetic reed, etc.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A vehicle-end database management system comprising a read/write controller and a vehicle-end database manager; wherein
the read/write controller is portable and having a central processing unit, an encoding/decoding unit, a non-contact transmission unit, an edit display unit and a write/read unit; the central processing unit is electrically connected to the encoding/decoding unit and the edit display unit while the write/read unit is electrically connected to the non-contact transmission unit and the encoding/decoding unit; a level value representing an end-user owning the read/write controller is built in the central processing unit and the central processing unit assigns the non-contact transmission unit an exclusive transmission authority according to the level value of the end-user for data transmission; the edit display unit is used to write the vehicle data and display the vehicle data written and read; the vehicle data written is displayed on the edit display unit in a real time manner after being processed by the central processing unit while the vehicle data written is sent to the encoding/decoding unit simultaneously by the central processing unit for being encoded; then the encoded vehicle data is passed through the write/read unit and is transmitted out by the non-contact transmission unit; the read/write controller receives the vehicle data read by the non-contact transmission unit; the received vehicle data is passed through the write/read unit and then is decoded by the encoding/decoding unit; the decoded vehicle data is passed through the central processing unit and is sent to the edit display unit to be displayed;
the vehicle-end database manager is arranged at a vehicle and having a vehicle-end central processing unit (CPU), a vehicle-end database, a vehicle-end non-contact transmission unit and a written/read unit; the vehicle-end CPU is electrically connected to the vehicle-end database and the written/read unit while the written/read unit is electrically connected to the vehicle-end non-contact transmission unit; the vehicle-end CPU is used for checking a level and authority of data written or data read; transmission authority of the vehicle-end non-contact transmission unit is determined according to transmission authority of end-users with different levels; each of the end-users has its own exclusive transmission authority for data transmission; a plurality of level data access area is built in the vehicle-end database according to the end-users with different levels; the end-user is checked according to the transmission authority; thus which level data access area of the vehicle-end database is/are accessible is determined according to the level value.

2. The system as claimed in claim 1, wherein a transmission way of the non-contact transmission unit and of the vehicle-end non-contact transmission unit is microwave transmission.

3. The system as claimed in claim 1, wherein a transmission way of the non-contact transmission unit and of the vehicle-end non-contact transmission unit is electromagnetic transmission.

4. The system as claimed in claim 1, wherein a transmission way of the non-contact transmission unit and of the vehicle-end non-contact transmission unit is by using magnetic reed.
